(19) United States
(12) Patent Application Publication
(10) Pub. No.: US 2015/0207387 A1
(43) Pub. Date: Jul. 23, 2015

(54) ROTARY ELECTRIC MACHINE

(71) Applicant: DENSO CORPORATION, Kariya-city (JP)

(72) Inventor: Yuichi KUDOSE, Chiryu-shi (JP)

(21) Appl. No.: 14/602,669

(22) Filed: Jan. 22, 2015

(30) Foreign Application Priority Data
Jan. 23, 2014 (JP) 2014-010469

(51) Int. Cl. H02K 9/19

(52) U.S. Cl. CPC H02K 9/19

(57) ABSTRACT

A rotary electric machine has a rotor, a stator with a stator core, an outer cylinder, a stator winding an end plate, and a refrigerant rail, and a cooling unit that drips a liquid refrigerant to an end part of the stator winding for cooling. The ring-shaped end plate is supported by the outer cylinder in at least one side in an axial direction of the stator core. The refrigerant rail with a dripping port where the supplied liquid refrigerant is dripped onto the coil end part is integrally formed at least with one of the end plates.

### CROSS-REFERENCE TO RELATED APPLICATION

This application is based on and claims the benefit of priority from earlier Japanese Patent Application No. 2014-10469 filed Jan. 23, 2014, the description of which is incorporated herein by reference.

### TECHNICAL FIELD

The present disclosure relates to a rotary electric machine used as an electric motor or a generator equipped in vehicles, for example.

### BACKGROUND

Conventionally, a rotary electric machine used as an electric motor or a generator in vehicles has a rotor, and a stator disposed opposing the rotor in a radial direction.

The stator has a stator core with a plurality of slots disposed in a circumferential direction and a stator winding wound around the slots of this stator core.

When an electric current flows into the stator winding in the rotary electric machine, the stator core and the stator winding generate heat.

In order to prevent the rotary electric machine from being damaged by the heat generated, it is necessary to cool the rotary electric machine, and an electric motor with a cooling structure is disclosed in Japanese Patent Application Laid-Open Publication No. 2011-78148, for example.

The electric motor disclosed in the Publication '148 has a stator with a stator core formed by assembling a plurality of split cores annularly, a fixing member (outer cylinder) with a cylindrical part engaged and fixed to an outer circumference of the stator core, and a stator winding wound around the stator core having coil end parts projecting towards both sides in an axial direction of the outer cylinder.

This electric motor is disposed outside the fixing member as well as has a refrigerant passage with openings located in upper parts of the coil end parts that are connected to a refrigerant supply source.

The fixing member has an inflow regulation wall that regulates the refrigerant flowed out from the openings in the refrigerant passages from flowing into a peripheral surface of the cylindrical part.

Since the refrigerant can be introduced into the coil end parts without making the refrigerant flow into the peripheral surface of the cylindrical part, an amount necessary for cooling the stator winding can be obtained and it becomes possible to cool the stator winding sufficiently.

In a case of the above-mentioned Publication '148, the refrigerant passage with the openings located in the upper parts of the coil end parts is disposed outside the fixing member, while the inflow regulation wall that regulates the refrigerant from flowing into the peripheral surface of the cylindrical part is disposed on the fixing member.

Therefore, in order to supply the refrigerant to appropriate positions of the coil end parts, a high dimensional accuracy of the fixing member is required.

### SUMMARY

An embodiment provides a rotary electric machine that can obtain efficient cooling effect without requiring a high dimensional accuracy of an outer cylinder.

In a rotary electric machine according to a first aspect, the rotary electric machine includes a rotor, a stator having a stator core formed by assembling a plurality of split cores annularly, an outer cylinder engaged and fixed to an outer circumference of the stator core and a stator winding wound around the stator core, and a cooling unit that supplies a liquid refrigerant to a coil end part of the stator winding for cooling.

A ring-shaped end plate is supported by the outer cylinder in at least one side in an axial direction of the stator core, and a refrigerant rail with a dripping port where the supplied liquid refrigerant is dripped onto the coil end part is integrally formed at least with one of the end plates.

According to the present disclosure, the ring-shaped end plate is supported by the outer cylinder in at least one side in the axial direction of the stator core, and the refrigerant rail with the dripping port where the supplied liquid refrigerant is dripped onto the coil end part is integrally formed at least with one of the end plates.

That is, since the refrigerant rail is formed integrally with the end plate supported by the outer cylinder, it becomes possible to fix the refrigerant rail on the outer cylinder through the end plate.

Therefore, since the refrigerant rails can be fixed to the outer cylinder with equal to or less dimensional accuracy of the stator core (split core) engaged and fixed to the outer cylinder, the outer cylinder does not require high dimensional accuracy.

Moreover, since the refrigerant rail is always kept cooled to low temperature by the contact of the supplied liquid refrigerant, the end plate 50 formed integrally with the refrigerant rails is cooled by the refrigerant rail, and the outer cylinder that supports the end plate is also cooled.

That is, in addition to cooling the stator windings and the stator core directly by the refrigerant dripped onto the coil end part from the dripping port of the refrigerant rail, the end plate and the outer cylinder are cooled simultaneously by the refrigerant rail that are always kept cooled to low temperature in the present disclosure.

Therefore, sufficient cooling effect can be obtained according to the present disclosure.

### BRIEF DESCRIPTION OF THE DRAWINGS

In the accompanying drawings:

FIG. 1 shows a sectional view along an axial direction of a rotary electric machine in a first embodiment;

FIG. 2A shows a plane view of a stator in the first embodiment;

FIG. 2B shows a front view of the stator seen from a lateral direction in the first embodiment;

FIG. 3 shows a plane view of a stator core in the first embodiment;

FIG. 4 shows a plane view of a segment of a split core in the first embodiment;

FIG. 5 shows a perspective view of a stator winding in the first embodiment;

FIG. 6 shows a sectional view of a conductor that composes the stator winding in the first embodiment;

FIG. 7 shows a perspective view of a refrigerant rail in the first embodiment;

FIG. 8 shows a disposition state of an end plate and a refrigerant rail in a first modification;

FIG. 9 shows a disposition state of an end plate and a refrigerant rail in a second modification;

FIG. 10 shows a sectional view along the axial direction of a stator in a second embodiment;

FIG. 11 shows a sectional view along the axial direction of a stator in a third modification; and

FIG. 12 shows a sectional view along the axial direction of a stator in a fourth modification.

### DETAILED DESCRIPTION OF THE PREFERRED EMBODIMENTS

Hereinafter, embodiments of a rotary electric machine are specifically explained with reference to the drawings.

### First Embodiment

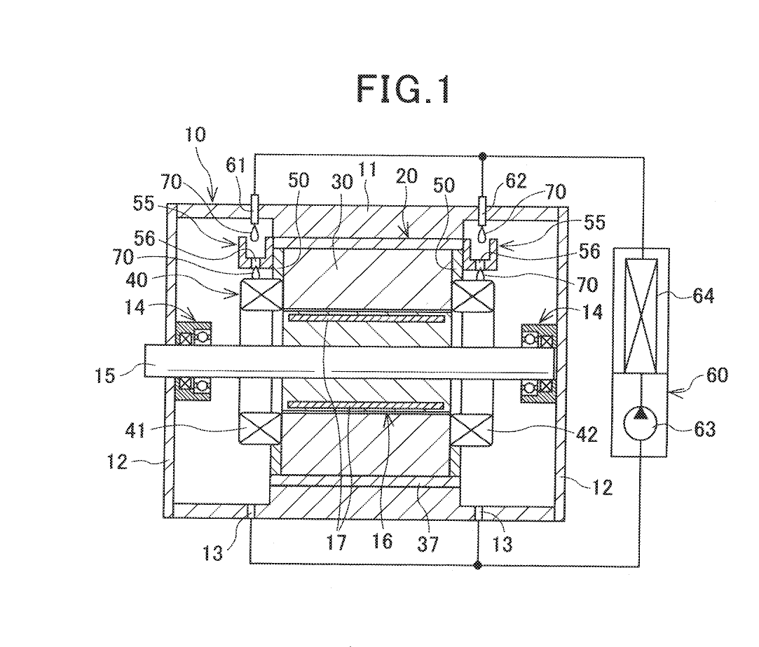

A rotary electric machine 1 of the present embodiment is employed as a motor for vehicles, and as shown in FIG. 1, it has a housing 10, a rotary shaft 15, a rotor 16, a stator 20 having a stator core 30, an outer cylinder 37, stator windings 40, end plates 50 and refrigerant rails 55, and a cooling unit 60.

The housing 10 is composed of a cylindrical main body 11 having both ends in an axial direction opened, and lids 12 fixed so as to seal both axial ends of the main body 11, respectively.

An outlet 13 is formed in a bottom wall of the main body 11. The outlet 13 discharges liquid refrigerant 70 supplied to the stator windings 40 from the cooling unit 60 outside the housing 10.

A pair of bearings 14 is disposed in a central part of inside each lid 12.

Both axial ends of the rotary shaft 15 are supported rotatably to the housing 10 through the pair of bearings 14.

A ring-like rotor 16 is engaged and fixed coaxially on an outer circumference in a central part in an axial direction of the rotary shaft 15.

A plurality of permanent magnet 17s is embedded in a periphery of the rotor 16 in the circumferential direction with predetermined intervals, and a plurality of magnetic poles that differ in polarity alternately in a circumferential direction is formed by the permanent magnets 17.

The number of the magnetic poles of the rotor 16 is limited because it differs depending on a rotary electric machine.

In the present embodiment, a rotor with 8 poles (4 N poles and 4 S poles) is adopted.

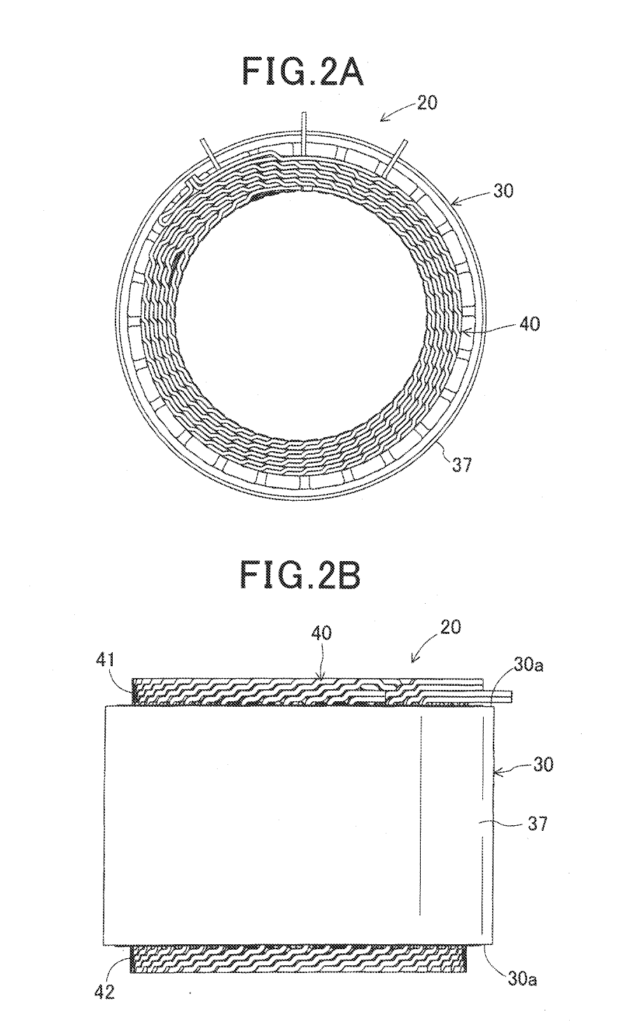

As shown in FIG. 2A and FIG. 2B, the stator 20 has a stator core composed of a plurality of split cores 32, and the three-phase stator windings 40 composed of a plurality of conductors wound around the stator core 30.

In addition, insulating paper may be disposed between the stator core 30 and the stator windings 40.

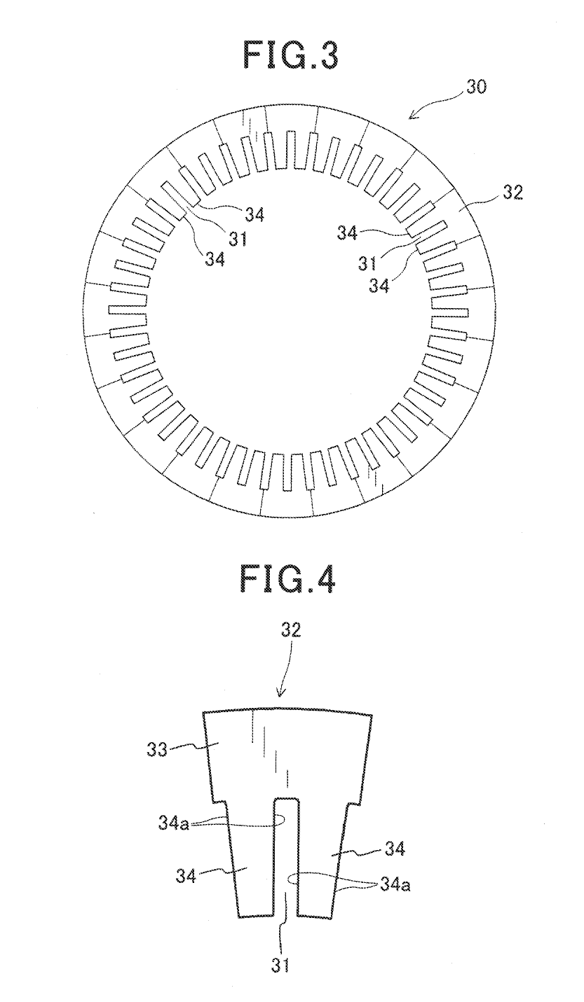

As shown in FIG. 3 and FIG. 4, the stator core 30 is formed by assembling the plurality of split cores 32 (24 pieces in the present embodiment) divided in the circumferential direction into a ring-like shape, and it has a plurality of slots 31 in an internal circumference side thereof arranged in the circumferential direction.

This the stator core 30 is composed of a ring-like back core 33 positioned in an outer circumference side thereof, and a plurality of teeth 34 projecting inwardly in a radial direction from back core 33 and arranged in the circumferential direction with predetermined intervals.

Thereby, a slot 31 that opens towards the internal circumference side of the stator core 30 and extends in the radial direction is formed between opposing sides 34a of the teeth 34 adjoining in the circumferential direction.

The sides 34a of the adjoining teeth 34 oppose each other in the circumferential direction, that is, a pair of sides 34a that divides a single slot 31 is formed in planes parallel to each other.

Thereby, each slot 31 extends in the radial direction with a fixed peripheral width dimension.

Since the stator windings 40 in the present embodiment adopt a double slot distributed winding, two slots 31 are formed per one phase of the stator windings relative to the number of magnetic poles (i.e., 8 poles) of the rotor 16. In other words, forty-eight slots 31 (8×3×2=48) are formed.

The forty-eight slots 31 are formed by the forty-eight teeth 34 having the same number as the slots 31 in this case.

The split cores 32 that compose the stator core 30 are formed by laminating in the axial direction a plurality of magnetic steel sheets formed into a predetermined shape by press punching.

The stator core 30 is fixed (for shape retaining) by engaging the outer cylinder 37 formed of iron metal, for example, to the outer circumference of the split cores 32 that are arranged like a ring (refer to FIG. 2A).

An axial length of the outer cylinder 37 is configured to a predetermined length (corresponds to the thickness of two end plates 50) bigger than an axial length of the stator core 30.

In a case of the present embodiment, the outer cylinder 37 is engaged and fixed to the outer circumference of the stator core 30 by press-fitting.

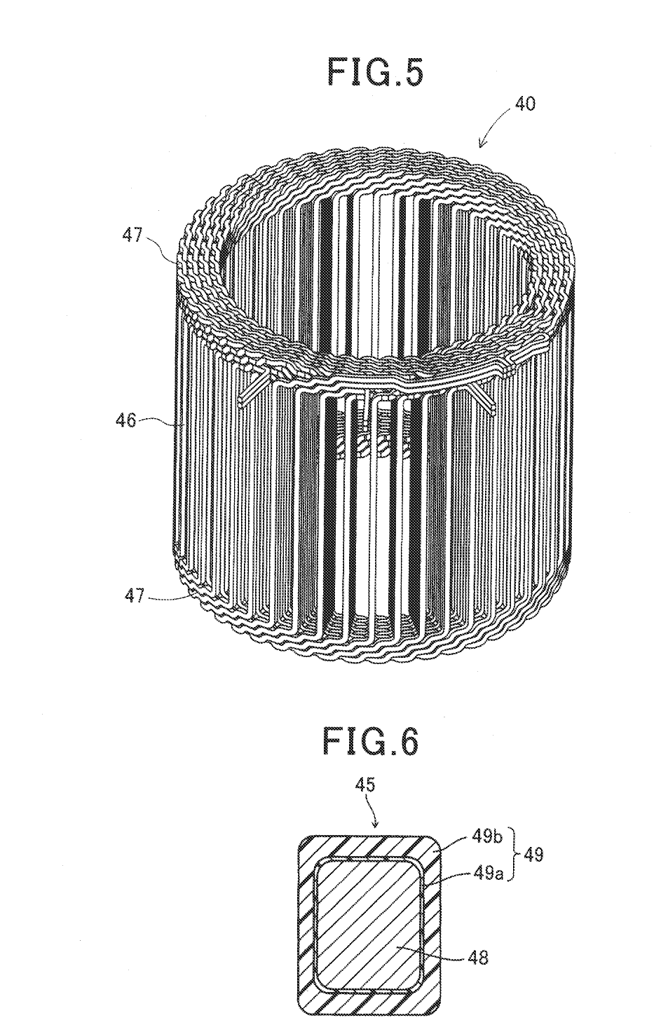

As shown in FIG. 5, the stator windings 40 are formed into a cylindrical shape by first forming belt-like conductor aggregates by laminating a predetermined number (8 in the present embodiment) of conductors (coil lines) 45 formed in a predetermined corrugated shape into a predetermined state, then winding the laminated conductors spirally.

The conductors 45 that compose the stator windings are formed into the corrugated shape having accommodating slot parts 46 that are accommodated in the slots 31 of the stator core 30, and turn parts 47 that connect accommodation parts 46 accommodated in the different slots 31 in the circumferential direction outside the slot 31.

As shown in FIG. 6, the conductor 45 adopts a flat wire made of a copper conductor 48 with a rectangular cross section and an insulating film 49 with an inner layer 49a and an outer layer 49b that covers the outer circumference of the conductor 48.

A thickness of insulating film 49 together with the inner layer 49a and the outer layer 49b is set to a range of 100 μm to 200 μm.

The stator windings 40 are assembled with the stator core 30 as the following.

That is, the teeth 34 of each split core 32 are inserted to the cylindrically formed stator windings 40 (refer to FIG. 5), all of the split cores 32 are positioned in the ring-like shape along the stator windings 40, and then the cylindrical outer cylinder 37 is engaged to the outer circumferences of the split cores 32

Thereby, as shown in FIG. 2A and FIG. 2B, the stator windings 40 are assembled in a state where a predetermined accommodating slot part 46 of each conductor 45 is accommodated in a predetermined slot 31 of the stator core 30.

In the present case, the accommodating slot part 46 of each conductor 45 is accommodated in the slot 31 of every predetermined number of slots (3-phase×2 (double slot)=6 in the present embodiment).

Further, the accommodating slot parts 46 of the conductors 45 of a predetermined number (8 in the present embodiment) are disposed to each slot 31 in a state aligned in a line in the radial direction of the core.

Moreover, the turn parts 47 that connect adjoining accommodating slot parts 46 of the conductors 45 are projected from both end faces 30a in the axial direction of the stator core 30, respectively.

By this, ring-like coil end parts 41, 42 are formed by many projected turn parts 47 to both ends in the axial direction of the stator winding 40 (refer to FIG. 2B).

In addition, in order to secure resistance against vibration of the stator windings 40 assembled to the stator core 30, the stator windings 40 are fixed to the stator core 30 by applying impregnation materials after the assembling is finished.

As shown in FIG. 1, the end plates 50 formed in the ring-like shapes and the refrigerant rails 55 formed integrally with the end plates 50 are respectively disposed on both sides in the axial direction of the stator core 30.

Each of the end plates 50 is engaged and supported by being press-fit into an internal circumferential surface in both ends in the axial direction of the outer cylinder 37, and each of the end plates 50 contacts axial end surfaces of the stator core 30.

Each of the refrigerant rails 55 is contacted to an upper part of both ends of the outer cylinder 37, and is positioned in a position above the coil end part 41, 42 of the stator windings 40.

Each of the refrigerant rails 55 has a dropping port 56 that drips the liquid refrigerant 70 supplied from the cooling unit 60 to the coil end parts 41, 42.

Further, in the present embodiment, one of the end plates 50 that has the refrigerant rail 55 formed integrally is assembled to the outer cylinder 37 before the split cores 32 are assembled to the outer cylinder 37, and is positioned axially by having the refrigerant rail 55 contacting the axial end surface of the outer cylinder 37.

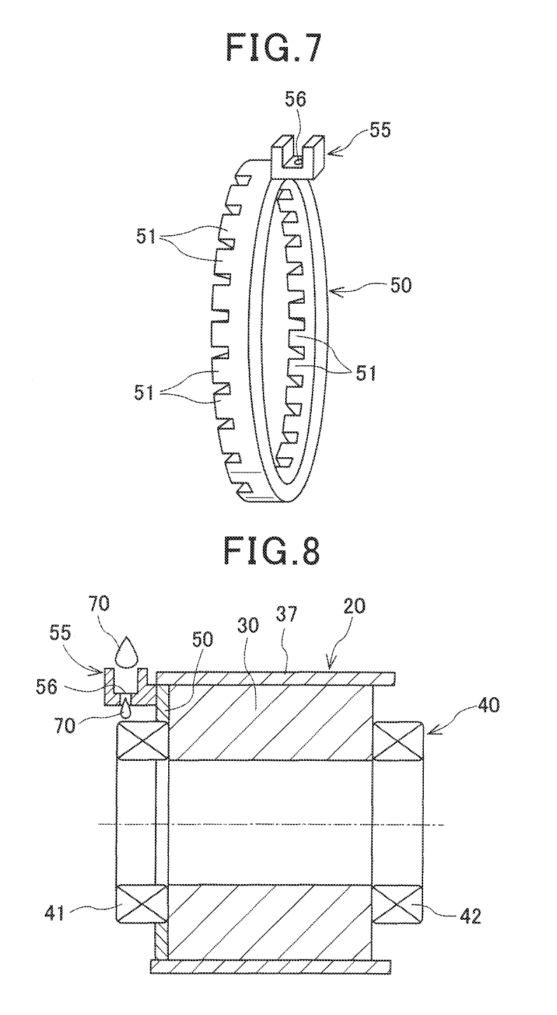

As shown in FIG. 7, the end plate 50 and the refrigerant rail 55 are joined integrally by welding, for example, after being formed separately of an iron-based metallic material.

The end plate 50 has a plurality of projections 51 projecting in the axial direction and abutting the end face of the stator core 30 on one of the surfaces that faces the end face of the stator core 30.

In a case of the present embodiment, the same numbers of the projections 51 to the split cores 32 are disposed at equal intervals in the circumferential direction.

That is, the number of the projections 51 and the number of the split cores 32 are configured to be the same and every projection 51 is configured to abut central parts in the circumferential direction of respective split core 32.

Further, surfaces of the end plates 50 and the refrigerant rails 55 are coated with an electrical insulation layer 57.

The cooling unit 60 has nozzles 61, 62 that discharge the liquid refrigerant 70 to each of the refrigerant rails 55, respectively, a pump 63 the feeds the liquid refrigerant 70 to each nozzle 61, 62, and a radiator 64 that releases heat of the heated liquid refrigerant 70.

Each nozzle 61, 62 is disposed in a predetermined position of a ceiling wall of the main body 11 of the housing 10, so that respective discharge opening of the nozzle 61, 62 is positioned above the each refrigerant rail 55.

The nozzles 61, 62, the pump 63, and the radiator 64 are connected by pipes for liquid refrigerant feeding, and are installed on a circulation circuit of the liquid refrigerant 70.

That is, in the cooling unit 60 of the present embodiment, the liquid refrigerant 70 discharged to each of the refrigerant rails 55 from each nozzle 61, 62 drips to the coil end parts 41, 42 from the dripping ports 56, and then the liquid refrigerant 70 flows downward while cooling the coil end parts 41, 42.

The liquid refrigerant 70 is collected to the pump 63 from the outlet 13 formed in the bottom of the housing 10, and the circulation circuit is formed so that after being cooled down by passing through the radiator 64 from the pump 63, the liquid refrigerant 70 is discharged from the nozzle 61, 62 again.

In addition, although an ATF (Automatic Transmission Fluid) is used as the liquid refrigerant 70 in the present embodiment, a commonly known liquid refrigerant used in a conventional rotary electric machine may be used.

Next, functions and effects of the rotary electric machine 1 constituted as above in the present embodiment are explained.

The rotary electric machine 1 of the present embodiment is disposed in a predetermined position of the vehicle so that as the rotary shaft 15 points in the horizontal direction, while the nozzles 61, 62 that discharge the liquid refrigerant 70 are positioned against gravity (i.e., on the upper side of the rotary electric machine 1) when in normal use.

When the rotary electric machine 1 begins driving by energization of the stator windings 40 of the stator 20, the rotary shaft 15 rotates following a rotation of the rotor 16, and drive force is supplied to other equipment from the rotary shaft 15.

Simultaneously, the pump 63 and the radiator 64 of the cooling unit 60 begin to operate, and the liquid refrigerant 70 is discharged to each the refrigerant rails 55 from the discharge openings of each nozzle 61, 62.

The liquid refrigerant 70 discharged from each nozzle 61, 62 is dripped onto the upper part surface of the outer circumference of each coil end parts 41, 42 from the dripping ports 56 of the refrigerant rails 55.

The dripped liquid refrigerant 70 falls down while cooling the coil end parts 41, 42 that are heated following the starting of driving.

At this time, in the present embodiment, since the refrigerant rails 55 are always kept cooled to low temperature by the contact of the supplied liquid refrigerant 70, the end plates 50 formed integrally with the refrigerant rails 55 are also cooled by the refrigerant rails 55, and the outer cylinder 37 that supports the end plates 50 is also cooled.

That is, in addition to cooling the stator windings 40 and the stator core 30 directly by the refrigerant 70 dripped onto the coil end parts 41, 42 from the dripping ports 56 of the refrigerant rails 55, the end plates 50 and the outer cylinder 37 are cooled simultaneously by the refrigerant rails 55 that are always kept cooled to low temperature in the present embodiment, sufficient cooling effect can be obtained.

Then, the liquid refrigerant 70 which has fallen from the coil end parts 41, 42 is returned to the pump 63 from the outlet 13 formed in the bottom of the housing 10, cooled by passing through the radiator 64 from the pump 63, discharged from the nozzles 61, 62 again, and circulates through the circulation circuit to cool the whole stator 20 repeatedly.

According to the rotary electric machine 1 of the present embodiment described above, the ring-shaped end plate 50 is supported by the outer cylinder 37 in at least one side in the axial direction of the stator core 30, and the refrigerant rail 55 with the dripping port 56 where the supplied liquid refrigerant 70 is dripped onto the coil end parts 41, 42 is integrally formed at least with one of the end plates 50.

That is, since the refrigerant rail 55 is formed integrally with the end plate 50 supported by the outer cylinder 37, it becomes possible to fix the refrigerant rail 55 on the outer cylinder 37 through the end plate 50.

Therefore, since the refrigerant rails 55 can be fixed to the outer cylinder 37 with equal to or less dimensional accuracy than the stator core 30 (split core 32) engaged and fixed to the outer cylinder 37, the outer cylinder 37 does not require high dimensional accuracy.

Moreover, since the refrigerant rail 55 of the present embodiment is always kept cooled to low temperature by the contact of the supplied liquid refrigerant 70, the end plate 50 formed integrally with the refrigerant rails 55 is cooled by the refrigerant rail 55, and the outer cylinder 37 that supports the end plate 50 is also cooled.

That is, in addition to cooling the stator windings 40 and the stator core 30 directly by the refrigerant 70 dripped onto the coil end parts 41, 42 from the dripping ports 56 of the refrigerant rails 55, the end plates 50 and the outer cylinder 37 are cooled simultaneously by the refrigerant rails 55 that are always kept cooled to low temperature in the present embodiment, sufficient cooling effect can be obtained.

Further, since the end plate 50 contacts the end face in the axial direction of the stator core 30 in the present embodiment, the axial location of the refrigerant rail 55 can be positioned easily.

Furthermore, since the heat of to the stator core 30 can be transferred to the refrigerant rails 55, a better cooling effect can be obtained.

Moreover, the end plate 50 of the present embodiment has the plurality of projections 51 projecting in the axial direction and formed to abut all split cores 32.

Thereby, the laminated steel sheets of the split cores that compose the stator core 30 can be reliably suppressed from peeling off or rising up and coming off by compressive stress of the outer cylinder 37.

Further, since the number of the projections 51 and the number of the split cores 32 are configured to be the same in the present embodiment, the laminated steel sheets of the split cores 32 can also be reliably suppressed from peeling off or coming off by compressive stress of the outer cylinder 37.

Further, in the present embodiment, since the end plates 50 and the refrigerant rails 55 have the electrical insulation layer 57 that covers the surfaces thereof, it is possible to secure a sufficient insulation with the stator windings 40 particularly in high-voltage rotary electric machine.

Further, in the present embodiment, one of the end plates 50 that has the refrigerant rail 55 formed integrally is assembled to the outer cylinder 37 before the split cores are assembled to the outer cylinder 37, and is positioned axially by having the refrigerant rail 55 contacting the outer cylinder 37.

Therefore, the split cores 32 assembled to the outer cylinder 37 after the end plates 50 can be easily positioned in the axial direction.

### [First Modification]

It should be appreciated that, in the first modification and the subsequent modifications or embodiments, components identical with or similar to those in the first embodiment are given the same reference numerals, and structures and features thereof will not be described in order to avoid redundant explanation.

Although the end plate 50 in which the refrigerant rail 55 is formed integrally is disposed respectively on both sides in the axial direction of the stator core 30 in the first embodiment mentioned above, the end plates 50 in which the refrigerant rail 55 is formed integrally may be disposed only on one side in the axial direction of the stator core 30 as the first modification shown in FIG. 8.

### [Second Modification]

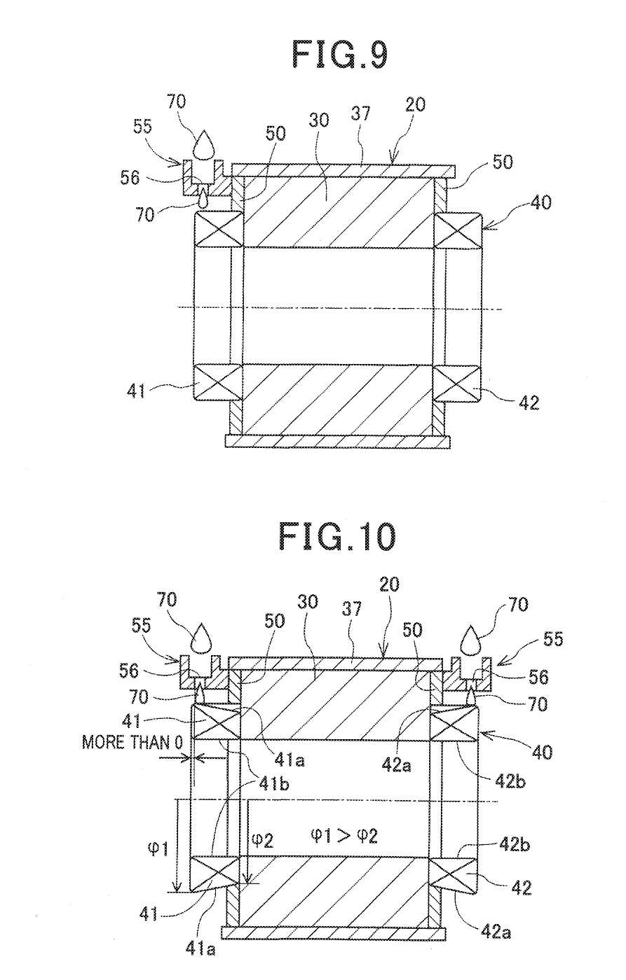

Further, an end plate 50 may be provided as the second modification shown in FIG. 9 instead of the first embodiment.

In this case, the end plate 50 in which the refrigerant rails 55 is formed integrally is disposed on one side in the axial direction of the stator core 30 (the left side in FIG. 9), and an end plate 50 having no refrigerant rail 55 is disposed on the other side in the axial direction of the stator core 30 (the right side in FIG. 9).

### Second Embodiment

The rotary electric machine 1 of the second embodiment has the same basic composition as that of the first embodiment, and a constitution of the coil end parts 41, 42 of the stator windings 40 is different from the first embodiment.

Therefore, only different points and important points are explained.

As shown in FIG. 10, the coil end parts 41, 42 of the stator windings 40 of the second embodiment have tapered outer surfaces 41a, 42a of which an outer diameter becomes smaller as an axial position thereof approaches toward the stator core 30 from an outer end in the axial direction.

That is, a radius φ1 the outer end in the axial direction of the coil end part 41, 42 is larger than a radius φ2 of an inner end in the axial direction of the coil end part 41, 42, and there exists a relation of φ1>φ2.

Thereby, the liquid refrigerant 70 dripped to the outer surfaces 41a, 42a of the coil end parts 41, 42 flows toward a small diameter side of the inner end in the axial direction and may become easy to be collected.

In addition, inner surfaces 41b, 42b of the coil end parts 41, 42 are formed straight parallel to a central axis of the stator core 30, and have a constant diameter from the outer end to the inner end in the axial direction.

Therefore, the thickness of the coil end parts 41, 42 in the radial direction becomes smaller as the axial position thereof approaches toward the stator core 30 from the outer end in the axial direction.

Further, the dripping ports 56 of the refrigerant rails 55 are configured to position nearer to the inner side in the axial direction of the coil end parts 41, 42.

That is, a distance between the outer end in the axial direction of the coil end part 41, 42 and an outer end in the axial direction of the dripping ports 56 is configured to be more than 0.

Thereby, the liquid refrigerant 70 dripping from the dripping ports 56 of the refrigerant rails 55 reliably sticks to the peripheral sides of the coil end parts 41, 42.

In this case, if the dripping ports 56 are brought as close as possible to the outer end in the axial direction of the coil end parts 41, 42, it becomes possible to drip the liquid refrigerant 70 in a wide range in the axial direction of the outer surfaces 41a, 42a of the coil end parts 41, 42, thus it is desirable.

The rotary electric machine 1 of the second embodiment composed like the above functions and effects like the rotary electric machine 1 of the first embodiment.

In the second embodiment in particular, the coil end parts 41, 42 of the stator windings 40 have tapered outer surfaces 41a, 42a of which the outer diameter becomes smaller as the axial position thereof approaches toward the stator core 30 from the outer end in the axial direction.

Thereby, the liquid refrigerant 70 dripped to the outer surfaces 41a, 42a of the coil end parts 41, 42 flows toward a small diameter side of the inner end in the axial direction and may become easy to be collected.

Therefore, the entire coil end parts 41, 42 can be cooled reliably and efficiently, and thus it becomes possible to obtain a better cooling effect.

### [Third Modification]

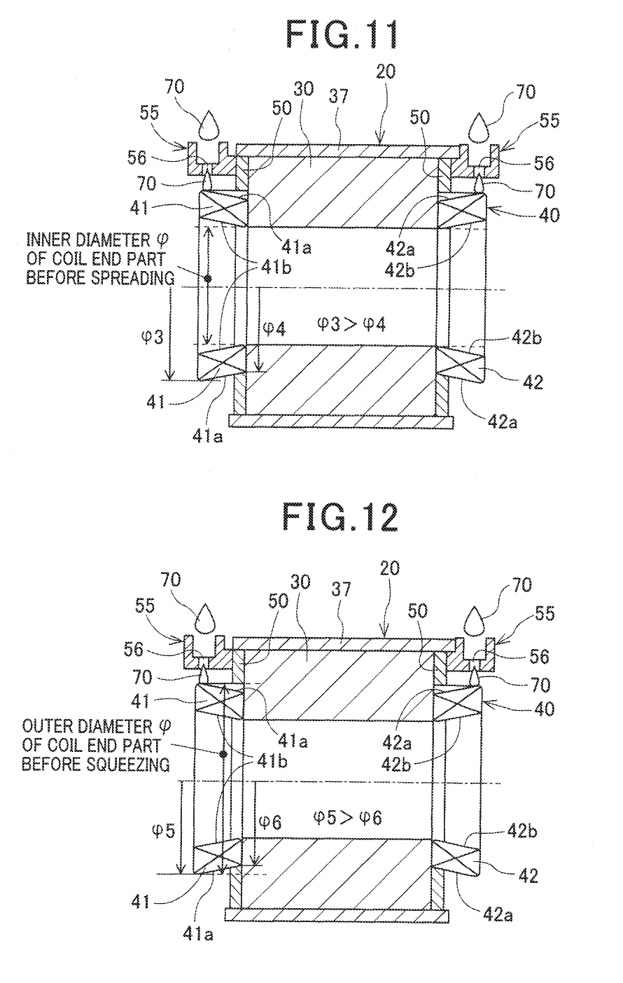

Although only the outer surfaces 41a, 42a of the coil end parts 41, 42 are formed in the tapered shape so as the outer diameter becomes smaller as the axial position thereof approaches toward the stator core 30 from the outer end in the axial direction in the second embodiment mentioned above, they may be formed as shown in the third modification in FIG. 11.

That is, in the third modification, both the outer surfaces 41a, 42a and the inner surfaces 41b, 42b of the coil end parts 41, 42 are formed in the tapered shape so as the outer diameter becomes smaller as the axial position thereof approaches toward the stator core 30 from the outer end in the axial direction.

Further, in the third modification, the thickness in the radial direction of the coil end parts 41, 42 is constant for the most part from the outer end to the inner end in the axial direction.

Moreover, in a case of the third modification, both the outer surfaces 41a, 42a and the inner surfaces 41b, 42b are formed in the tapered shapes at the same time by spreading out the outer end in the axial direction of the inner surfaces 41b, 42b of the coil end parts 41, 42 toward outside in the axial direction.

### [Fourth Modification]

Further, the coil end parts 41, 42 may be provided as the fourth modification shown in FIG. 12 instead of the second embodiment.

In this case, like the third modification, both the outer surfaces 41a, 42a and the inner surfaces 41b, 42b of the coil end parts 41, 42 are formed in the tapered shape so as the outer diameter becomes smaller as the axial position thereof approaches toward the stator core 30 from the outer end in the axial direction.

Further, like the third modification, the thickness of in the radial direction of the coil end parts 41, 42 is constant for the most part from the outer end to the inner end in the axial direction.

However, the fourth modification differs from the third modification in that both the outer surfaces 41a, 42a and the inner surfaces 41b, 42b are formed in the tapered shapes at the same time by squeezing the inner end in the axial direction of the inner surfaces 41b, 42b of the coil end parts 41, 42 inwardly in the radial direction.

### Other Embodiments

Although the preferred embodiments of the present disclosure are described above, the present disclosure is not limited in any way to the embodiments described above, and may be implemented in various modifications without departing from scopes of the present disclosure.

For example, although each of the end plates 50 is engaged and supported to the inner surfaces of both ends in the axial direction of the outer cylinder 37 by press-fitting in the first and second embodiments, a technique of shrink-fitting or the like may be adopted instead of press-fitting.

Further, although the number of the projections 51 of the end plate and the number of the split cores 32 are the same and every projection 51 is configured to abut central parts in the circumferential direction of all split cores 32 in the first and second embodiments, each projection 51 may be configured to bridge across two adjoining split cores 32 and abut the two adjoining split cores 32 instead.

Accordingly, since the projection 51 is configured to abut both ends in the circumferential direction of the split core 32, the laminated steel sheets of the split cores 32 can be reliably suppressed from peeling off or coming off by compressive stress of the outer cylinder 37.

Further, although the rotary electric machine according to the present disclosure is being applied to a motor (electric motor) described as examples in the first and second embodiments, the present disclosure may be applied to a generator, an electric motor, or a rotary electric machine that can be selectively used as either a generator or an electric motor as the rotary electric machine mounted on the vehicle.

What is claimed is:

1. A rotary electric machine comprising:
a rotor;
a stator having a stator core formed by assembling a plurality of split cores annularly, an outer cylinder engaged and fixed to an outer circumference of the stator core and a stator winding wound around the stator core; and
a cooling unit that supplies a liquid refrigerant to a coil end part of the stator winding for cooling; wherein,
a ring-shaped end plate is supported by the outer cylinder in at least one side in an axial direction of the stator core; and
a refrigerant rail with a dripping port where the supplied liquid refrigerant is dripped onto the coil end part is integrally formed at least with one of the end plates.

2. The rotary electric machine according to claim 1, wherein,
the end plate contacts an axial end surface of the stator core.

3. The rotary electric machine according to claim 2, wherein,
the end plate has a plurality of projections projecting in the axial direction that abut all of the stator cores.

4. The rotary electric machine according to claim 3, wherein,
the number of the projections and the number of the split cores are the same.

5. The rotary electric machine according to claim 1, wherein,
the end plate and the refrigerant rail have an electrical insulation layer that covers surfaces of the end plate and the refrigerant rail.

6. The rotary electric machine according to claim 1, wherein,
one of the end plates that has the refrigerant rail formed integrally is assembled to the outer cylinder before the split cores are assembled to the outer cylinder, and is positioned axially by having the refrigerant rail contacting an axial end surface of the outer cylinder.

7. The rotary electric machine according to claim 1, wherein,
the coil end part has tapered outer surface of which an outer diameter becomes smaller as an axial position thereof approaches toward the stator core from an outer end in the axial direction; and
the dripping port of the refrigerant rail is configured to position nearer to an inner side in the radial direction of the coil end part.
